(19) United States
(12) Patent Application Publication
(10) Pub. No.: US 2014/0092435 A1
(43) Pub. Date: Apr. 3, 2014

(54) APPLYING INDIVIDUAL PREFERENCES TO PRINTED DOCUMENTS

(71) Applicant: INTERNATIONAL BUSINESS MACHINES CORPORATION, Armonk, NY (US)

(72) Inventors: GARY D. CUDAK, CREEDMOOR, NC (US); CHRISTOPHER J. HARDEE, RALEIGH, NC (US); RANDALL C. HUMES, RALEIGH, NC (US); ADAM ROBERTS, MONCURE, NC (US)

(73) Assignee: INTERNATIONAL BUSINESS MACHINES CORPORATION, ARMONK, NY (US)

(21) Appl. No.: 13/630,722

(22) Filed: Sep. 28, 2012

(51) Int. Cl. G06K 15/02

(52) U.S. Cl. 358/1.16

(57) ABSTRACT

Applying individual preferences to printed documents, including: receiving, by a preference application module, a print request; identifying, by the preference application module, one or more identifiers of users associated with the print request; retrieving, by the preference application module, print preferences for the one or more identifiers of users associated with the print request; and generating, by the preference application module, one or more individualized print jobs for each of the users in dependence upon the print preferences.

### BACKGROUND OF THE INVENTION

1. Field of the Invention

The field of the invention is data processing, or, more specifically, methods, apparatus, and products for applying individual preferences to printed documents.

2. Description of Related Art

Modern computers are frequently coupled to printers for printing copies of content received by, generated by, or otherwise viewable on a computer. Documents are printed typically in a one size fits all manner in the sense that printing multiple copies of a single document results in identical printed documents, in spite of the fact that each person receiving a copy of the printed document may have different needs.

### SUMMARY OF THE INVENTION

Methods, apparatus, and products for applying individual preferences to printed documents, including: receiving, by a preference application module, a print request; identifying, by the preference application module, one or more identifiers of users associated with the print request; retrieving, by the preference application module, print preferences for the one or more identifiers of users associated with the print request; and generating, by the preference application module, one or more individualized print jobs for each of the users in dependence upon the print preferences.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in applying individual preferences to printed documents according to embodiments of the present invention.

FIG. 2 sets forth a flow chart illustrating an example method for applying individual preferences to printed documents according to embodiments of the present invention.

FIG. 3 sets forth a flow chart illustrating a further example method for applying individual preferences to printed documents according to embodiments of the present invention.

### DETAILED DESCRIPTION OF EXAMPLE EMBODIMENTS

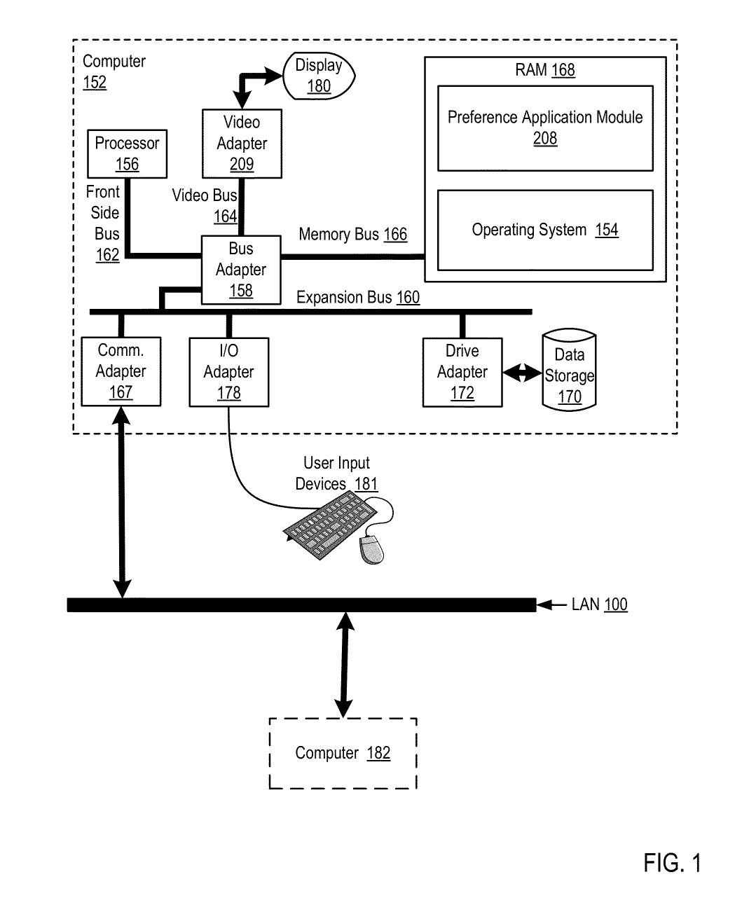

Example methods, apparatus, and products for applying individual preferences to printed documents in accordance with the present invention are described with reference to the accompanying drawings, beginning with FIG. 1. FIG. 1 sets forth a block diagram of automated computing machinery comprising an example computer (152) useful in applying individual preferences to printed documents according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a preference application module (208), a module of computer program instructions for applying individual preferences to printed documents according to embodiments of the present invention. The preference application module (208) of FIG. 1 can apply individual preferences to printed documents by receiving a print request. The print request represents a request initiated by a software application to print some digital content. The print request may be initiated, for example, by a word processing application, by a web browser, by a presentation application, and so on. The print request may be embodied as a message that is sent to a rendering device such as a printer. The print request can include information identifying a user of the machine that the print request came from, information identifying the application that generated the print request, information that includes the content of the document that is to be printed, and so on.

In the example of FIG. 1, the print request can also include one or more identifiers of users associated with the print request. Users that are associated with the print request may include, for example, a user that is logged in to the machine that generated the print request, other users who are intended to be recipients of the printed document, and so on. In such an example, the users that are associated with the print request may be specified when the print request is being initiated. Consider an example in which a particular user wants to print multiple copies of a document that has been generated using a word processing application. In such an example, the word processing application can include an icon, a selectable entry in a list, or other mechanism that enables the user to initiate a print request. After clicking on such an icon, selectable entry in a list, or other mechanism that enables the user to initiate a print request, the user of the word processing application can be presented with a graphical user interface that allows the user to customize the print request. For example, the user can select the printer that will service the print request, the user can specify the number of copies of the document that are to be printed, the user can specify the particular pages that are to be printed, and so on. A word processing application that is improved in accordance with embodiments of the present application can also allow a user to specify users associated with the print request, for example, through a drop down box, multiselect box, text field, or other component of the graphical user interface that allows the user to customize the print request.

The preference application module (208) of FIG. 1 can further apply individual preferences to printed documents by identifying one or more identifiers of users associated with the print request. Identifying one or more identifiers of users associated with the print request may be carried out by examining the print request itself. As described above, the print request can include one or more identifiers of users associated with the print request. As such, the one or more identifiers of users associated with the print request may be extracted from the print request itself. Alternatively, the one or more identifiers of users associated with the print request may be extrapolated in other ways. For example, a particular set of users may be associated with each physical printed such that the one or more identifiers of users associated with the print request can be identified based on the printer that was selected to service the print request. In another example, a particular set of users may be associated with each software application that generates the print request such that the one or more identifiers of users associated with the print request can be identified based on which software application generated the print request. In another example, a particular set of users may be associated with a particular user that initiates the print request such that the one or more identifiers of users associated with the print request can be identified based on which user initiated the print request. Readers will appreciate that the examples set forth above are included for illustration and do not represent an exhaustive list of the manner in which the one or more identifiers of users associated with the print request may be identified.

The preference application module (208) of FIG. 1 can further apply individual preferences to printed documents by retrieving print preferences for the one or more identifiers of users associated with the print request. The print preferences for each user that is associated with the print request can include information describing the manner in which a particular document should be printed for that particular user. For example, the print preferences for a particular user can include the font size to be used when printing a document, an identification of the device (e.g., a brail printer) to use when printing a document, and other configurable options to use when printing a document.

Consider an example in which a particular user, User 1, is printing three copies of a particular document that is to be discussed in a group meeting that is also attended by User 2 and User 3. Assume User 2 has poor eye sight and has difficulty reading documents that are printed in a font-size lower than 16. Further assume that User 1 and User 3 have excellent eye sight and prefer documents that are printed in a font-size of 10 so as to allow for more information to appear on a single page and reduce the amount of paper that is consumed to print a document. In such an example, the print preferences for User 2 may include a field that specifies a font-size of 16, while the print preferences for User 1 and User 3 include a field that specifies a font-size of 10.

The preference application module (208) of FIG. 1 can further apply individual preferences to printed documents by generating one or more individualized print jobs for each of the users in dependence upon the print preferences. Each of the one or more individualized print jobs represents a message that is sent to a rendering device (e.g., a printer) to print some content in accordance with the preferences specified in the print preferences for each user that is associated with the print request.

Consider the example described above in which a particular user, User 1, is printing three copies of a particular document that is to be discussed in a group meeting that is also attended by User 2 and User 3. In the example described above, the print preferences for User 2 include a field that specifies a font-size of 16, while the print preferences for User 1 and User 3 include a field that specifies a font-size of 10. In such an example, generating one or more individualized print jobs for each of the users in dependence upon the print preferences would result in the generation of three individualized print jobs. The print job associated with User 2 would represent an instruction to print the document using size 16 font and the other two print jobs would each represent an instruction to print the document using size 10 font.

Also stored in RAM (168) is an operating system (154). Operating systems useful applying individual preferences to printed documents according to embodiments of the present invention include UNIX™, Linux™, Microsoft XP™, AIX™, IBM's i5/OS™, and others as will occur to those of skill in the art. The operating system (154) and preference application module (208) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for applying individual preferences to printed documents according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for applying individual preferences to printed documents according to embodiments of the present invention include modems for wired dial-up communications, Ethernet (IEEE 802.3) adapters for wired data communications network communications, and 802.11 adapters for wireless data communications network communications.

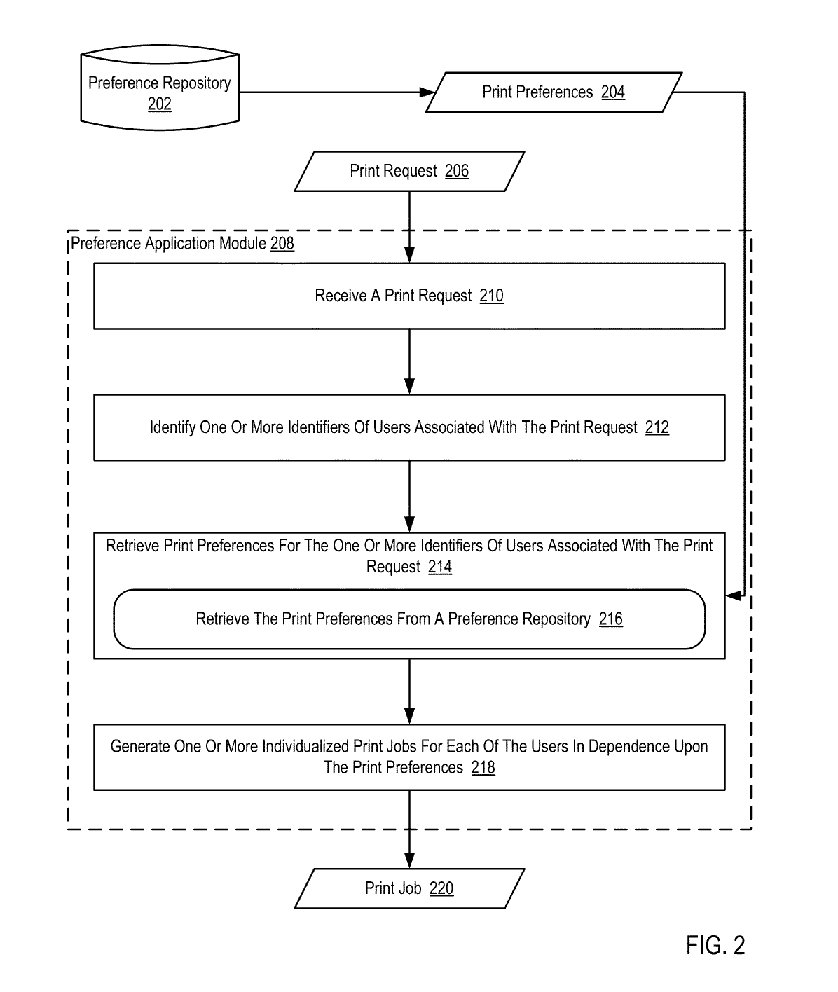

For further explanation, FIG. 2 sets forth a flow chart illustrating an example method for applying individual preferences to printed documents according to embodiments of the present invention. Various aspects of the example method of FIG. 2 are carried out by a preference application module (208). The preference application module (208) of FIG. 2 may be embodied, for example, as a module of computer program instructions that are executed on computer hardware. The preference application module (208) of FIG. 2 may be embodied, for example, as a plugin to a word processing application, as a component of a word processing application or other software application capable of initiating print jobs, as a driver on a printer, and in other ways as will occur to those of skill in the art. The example method of FIG. 2 includes receiving (210), by a preference application module (208), a print request (206). In the example method of FIG. 2, a print request (206) represents a request initiated by a software application to print some digital content. The print request (206) may be initiated, for example, by a word processing application, by a web browser, by a presentation application, and so on. In the example method of FIG. 2, the print request (206) may be embodied as a message that is sent to a rendering device such as a printer. The print request (206) can include information identifying a user of the machine that the print request (206) came from, information identifying the application that generated the print request, information that includes the content of the document that is to be printed, and so on.

In the example method of FIG. 2, the print request (206) can also include one or more identifiers of users associated with the print request (206). Users that are associated with the print request (206) may include, for example, a user that is logged in to the machine that generated the print request, other users who are intended to be recipients of the printed document, and so on. In such an example, the users that are associated with the print request (206) may be specified when the print request (206) is being initiated. Consider an example in which a particular user wants to print multiple copies of a document that has been generated using a word processing application. In such an example, the word processing application can include an icon, a selectable entry in a list, or other mechanism that enables the user to initiate a print request (206). After clicking on such an icon, selectable entry in a list, or other mechanism that enables the user to initiate a print request (206), the user of the word processing application can be presented with a graphical user interface that allows the user to customize the print request (206). For example, the user can select the printer that will service the print request, the user can specify the number of copies of the document that are to be printed, the user can specify the particular pages that are to be printed, and so on. In the example method of FIG. 2, a word processing application that is improved in accordance with embodiments of the present application can also allow a user to specify users associated with the print request (206), for example, through a drop down box, multiselect box, text field, or other component of the graphical user interface that allows the user to customize the print request (206).

The example method of FIG. 2 also includes identifying (212), by the preference application module (208), one or more identifiers of users associated with the print request (206). In the example method of FIG. 2, identifying (212) one or more identifiers of users associated with the print request (206) may be carried out by examining the print request (206) itself. As described above, the print request (206) of FIG. 2 can include one or more identifiers of users associated with the print request (206). As such, the one or more identifiers of users associated with the print request (206) may be extracted from the print request (206) itself. Alternatively, the one or more identifiers of users associated with the print request (206) may be extrapolated in other ways. For example, a particular set of users may be associated with each physical printed such that the one or more identifiers of users associated with the print request (206) can be identified (212) based on the printer that was selected to service the print request (206). In another example, a particular set of users may be associated with each software application that generates the print request (206) such that the one or more identifiers of users associated with the print request (206) can be identified (212) based on which software application generated the print request (206). In another example, a particular set of users may be associated with a particular user that initiates the print request (206) such that the one or more identifiers of users associated with the print request (206) can be identified (212) based on which user initiated the print request (206). Readers will appreciate that the examples set forth above are included for illustration and do not represent an exhaustive list of the manner in which the one or more identifiers of users associated with the print request (206) may be identified (212).

The example method of FIG. 2 also includes retrieving (214), by the preference application module (208), print preferences (204) for the one or more identifiers of users associated with the print request (206). In the example method of FIG. 2, the print preferences (204) for each user that is associated with the print request (206) can include information describing the manner in which a particular document should be printed for that particular user. For example, the print preferences (204) for a particular user can include the font size to be used when printing a document, an identification of the device (e.g., a brail printer) to use when printing a document, and other configurable options to use when printing a document.

Consider an example in which a particular user, User 1, is printing three copies of a particular document that is to be discussed in a group meeting that is also attended by User 2 and User 3. Assume User 2 has poor eye sight and has difficulty reading documents that are printed in a font-size lower than 16. Further assume that User 1 and User 3 have excellent eye sight and prefer documents that are printed in a font-size of 10 so as to allow for more information to appear on a single page and reduce the amount of paper that is consumed to print a document. In such an example, the print preferences (204) for User 2 may include a field that specifies a font-size of 16, while the print preferences (204) for User 1 and User 3 include a field that specifies a font-size of 10.

In the example method of FIG. 2, retrieving (214) print preferences (204) for the one or more identifiers of users associated with the print request (206) can include retrieving (216) the print preferences (204) from a preference repository (202). The preference repository (202) of FIG. 2 may be embodied, for example, as a table, database, or other data structure that is stored in computer memory that is accessible by the preference application module (208). The preference repository (202) of FIG. 2 can include an entry for each known user as well as fields that specify various preferences for each user. Such preferences can include, for example, a preferred font-size, a preference identifying whether the user prefers color copies or black-and-white copies, a preferred printer, a preferred border size, a preferred language for the document, a preferred page orientation (e.g., landscaped), a preferred font type, and others as will occur to those of skill in the art.

The example method of FIG. 2 also includes generating (218), by the preference application module (208), one or more individualized print jobs (220) for each of the users in dependence upon the print preferences (204). In the example method of FIG. 2, each of the one or more individualized print jobs (220) represents a message that is sent to a rendering device (e.g., a printer) to print some content in accordance with the preferences specified in the print preferences (204) for each user that is associated with the print request (206).

Consider the example described above in which a particular user, User 1, is printing three copies of a particular document that is to be discussed in a group meeting that is also attended by User 2 and User 3. In the example described above, the print preferences (204) for User 2 include a field that specifies a font-size of 16, while the print preferences (204) for User 1 and User 3 include a field that specifies a font-size of 10. In such an example, generating (218) one or more individualized print jobs (220) for each of the users in dependence upon the print preferences (204) would result in the generation of three individualized print jobs (220). The print job associated with User 2 would represent an instruction to print the document using size 16 font and the other two print jobs would each represent an instruction to print the document using size 10 font.

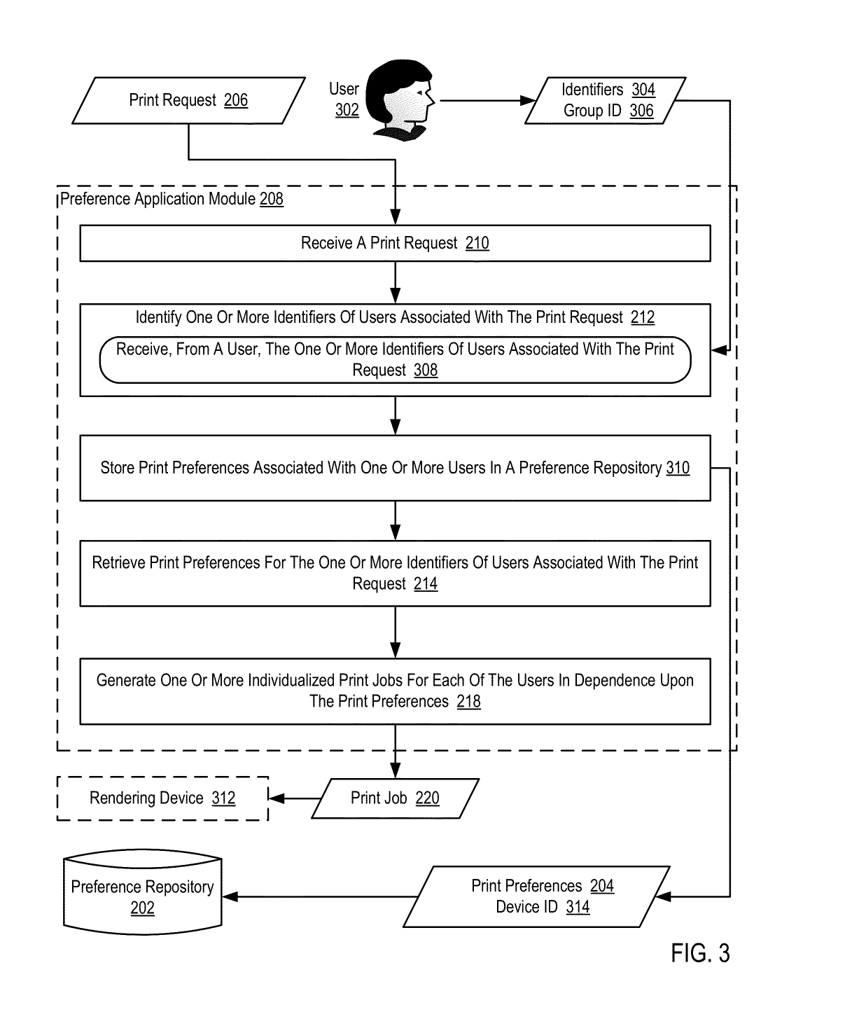

For further explanation, FIG. 3 sets forth a flow chart illustrating a further example method for applying individual preferences to printed documents according to embodiments of the present invention. The example method of FIG. 3 is similar to the example method of FIG. 2 as it also includes receiving (210) a print request (206), identifying (212) one or more identifiers of users associated with the print request (206), retrieving (214) print preferences (204) for the one or more identifiers of users associated with the print request (206), and generating (218) one or more individualized print jobs (220) for each of the users in dependence upon the print preferences (204).

In the example method of FIG. 3, identifying (212) one or more identifiers (304) of users associated with the print request (206) includes receiving (308), by the preference application module (208) from a user (302), the one or more identifiers (304) of users associated with the print request (206). The user (302) of FIG. 3 can include, for example, the user of a software application such as a word processing document that initiates the print request (206). Receiving (308) the one or more identifiers (304) of users associated with the print request (206) from a user (302) may be carried out, for example, by presenting a user interface to the user for selecting or otherwise identifying other users that are to be associated with the print request (206).

Consider an example in which a particular user wants to print multiple copies of a document that has been generated using a word processing application. In such an example, the word processing application can include an icon, a selectable entry in a list, or other mechanism that enables the user to initiate a print request (206). After clicking on such an icon, selectable entry in a list, or other mechanism that enables the user to initiate a print request (206), the user of the word processing application can be presented with a graphical user interface that allows the user to customize the print request (206). For example, the user can select the printer that will service the print request, the user can specify the number of copies of the document that are to be printed, the user can specify the particular pages that are to be printed, and so on. In the example method of FIG. 3, a word processing application that is improved in accordance with embodiments of the present application can also allow a user to specify users associated with the print request (206), for example, through a drop down box, multiselect box, text field, or other component of the graphical user interface that allows the user to customize the print request (206).

In the example method of FIG. 3, the one or more identifiers (304) of users associated with the print request (206) may be identified by a group identifier (306). In the example method of FIG. 3, the group identifier (306) may be embodied as some value that represents a plurality of users. Such a group identifier (306) may be used to represent all members of a particular project team, members of a particular organizational group, and so on. Through the use of a group identifier (306), multiple users may be associated with a particular print request (206) without needing to specify every single user during the processing of initiating the print request (206).

The example method of FIG. 3 also includes storing (310), by the print preference application module (208), print preferences (204) associated with one or more users in a preference repository (202). In the example method of FIG. 3, storing (310) print preferences (204) associated with one or more users in a preference repository may be carried out, for example, through the use of a graphical user interface presented to a user (302) that allows the user to create a printing preferences entry for one or more users. Through the use of such a graphical user interface, a message may be generated and sent to the preference repository (202) that contains the printing preferences for a user and a request to create an entry for the user, or to update an already existing entry for the user. Alternatively, the generation of printing preferences could be an automated process in which the first time a particular user initiates a print request (206), the preferences associated with the print request are assumed to be the print preferences (204) for the user (302) and a default entry is created in the preference repository (202).

In the example method of FIG. 3, the print preferences (204) for the one or more identifiers of users associated with the print request (206) can include an identifier of a rendering device (312) for servicing the print request (206). In the example method of FIG. 3, the rendering device (312) can be a particular printer, copier, or other device configured to service the print request (206). The device identifier (314) for such a rendering device (312) may be embodied as, for example, a device name, a network address for the device (312), and so on. Although the examples described above describe the rendering device (312) as being a printer, brail printer, copier, and the like, readers will appreciate that the rendering device (312) may take other forms. Consider an example in which one of the users associated with a print request (206) is blind. In such an example, through the use of text-to-speech technologies, the content to be printed could be translated to speech and delivered to a rendering device (312) such as a mobile communications device that can play audio files.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of applying individual preferences to printed documents, the method comprising:
receiving, by a preference application module, a print request;
identifying, by the preference application module, one or more identifiers of users associated with the print request;
retrieving, by the preference application module, print preferences for the one or more identifiers of users associated with the print request; and
generating, by the preference application module, one or more individualized print jobs for each of the users in dependence upon the print preferences.

2. The method of claim 1 wherein retrieving, by the preference application module from a preference repository, print preferences for the one or more identifiers of users associated with the print request further comprises retrieving the print preferences from a preference repository.

3. The method of claim 1 wherein identifying, by the preference application module, one or more identifiers of users associated with the print request further comprises receiving, by the preference application module from a user, the one or more identifiers of users associated with the print request.

4. The method of claim 1 wherein the one or more identifiers of users associated with the print request are identified by a group identifier.

5. The method of claim 1 further comprising storing, by the print preference application module, print preferences associated with one or more users in a preference repository.

6. The method of claim 1 wherein the print preferences for the one or more identifiers of users associated with the print request includes an identifier of a rendering device for servicing the print request.

7. An apparatus for applying individual preferences to printed documents, the apparatus comprising a computer processor, a computer memory operatively coupled to the computer processor, the computer memory having disposed within it computer program instructions that, when executed by the computer processor, cause the apparatus to carry out the steps of:
receiving, by a preference application module, a print request;
identifying, by the preference application module, one or more identifiers of users associated with the print request;
retrieving, by the preference application module, print preferences for the one or more identifiers of users associated with the print request; and
generating, by the preference application module, one or more individualized print jobs for each of the users in dependence upon the print preferences.

8. The apparatus of claim 7 wherein retrieving, by the preference application module from a preference repository, print preferences for the one or more identifiers of users associated with the print request further comprises retrieving the print preferences from a preference repository.

9. The apparatus of claim 7 wherein identifying, by the preference application module, one or more identifiers of users associated with the print request further comprises receiving, by the preference application module from a user, the one or more identifiers of users associated with the print request.

10. The apparatus of claim 7 wherein the one or more identifiers of users associated with the print request are identified by a group identifier.

11. The apparatus of claim 7 further comprising computer program instructions that, when executed by the computer processor, cause the apparatus to carry out the step of storing, by the print preference application module, print preferences associated with one or more users in a preference repository.

12. The apparatus of claim 7 wherein the print preferences for the one or more identifiers of users associated with the print request includes an identifier of a rendering device for servicing the print request.

13. A computer program product for applying individual preferences to printed documents, the computer program product disposed upon a computer readable medium, the computer program product comprising computer program instructions that, when executed, cause a computer to carry out the steps of:
receiving, by a preference application module, a print request;
identifying, by the preference application module, one or more identifiers of users associated with the print request;
retrieving, by the preference application module, print preferences for the one or more identifiers of users associated with the print request; and
generating, by the preference application module, one or more individualized print jobs for each of the users in dependence upon the print preferences.

14. The computer program product of claim 13 wherein retrieving, by the preference application module from a preference repository, print preferences for the one or more identifiers of users associated with the print request further comprises retrieving the print preferences from a preference repository.

15. The computer program product of claim 13 wherein identifying, by the preference application module, one or more identifiers of users associated with the print request further comprises receiving, by the preference application module from a user, the one or more identifiers of users associated with the print request.

16. The computer program product of claim 13 wherein the one or more identifiers of users associated with the print request are identified by a group identifier.

17. The computer program product of claim 13 further comprising computer program instructions that, when executed, cause the computer to carry out the step of storing, by the print preference application module, print preferences associated with one or more users in a preference repository.

18. The computer program product of claim 13 wherein the print preferences for the one or more identifiers of users associated with the print request includes an identifier of a rendering device for servicing the print request.

19. The computer program product of claim 13 wherein the computer readable medium comprises a signal medium.

20. The computer program product of claim 13 wherein the computer readable medium comprises a storage medium.
